(19) United States
(12) Patent Application Publication
(10) Pub. No.: US 2026/0269856 A1
(43) Pub. Date: Sep. 10, 2026

(54) SYSTEM AND A DEVICE FOR A COMPACT, PREPROGRAMMED TRANSCEIVER

(71) Applicant: Scott Ahn, Lenexa, TX (US)

(72) Inventor: Scott Ahn, Lenexa, TX (US)

(21) Appl. No.: 19/058,157

(22) Filed: Mar. 7, 2025

(51) Int. Cl. H04B 1/3827; H04B 1/54

(52) U.S. Cl. CPC H04B 1/3833; H04B 1/54

(57) ABSTRACT

A system includes a portable radio communications device is for transmitting data and voice communications. The portable radio communications device may include a portable housing, a radio transceiver operating at a frequency in a range of 30 MHz-3000 MHz and being carried by the portable housing for direct communication with a corresponding radio transceiver. The portable radio communications device may also include a controller carried by the portable housing for selectively allocating transmission of the data and voice communications for the radio transceiver.

### CROSS-REFERENCES TO RELATED APPLICATIONS

N/A.

### FIELD OF THE TECHNOLOGY

The present disclosure generally relates devices that operate in the UHF range and are compact in size (hand-held), portable and pre-programmed with software and, more specifically, to a pocket sized, compact and easy to use long range UHF digital business radio without programming features.

### DESCRIPTION OF THE RELATED ART

Effective communication may be important to any large organization that rapidly deploys and moves personnel to different areas, for example, law enforcement, and fire departments. These organizations typically comprise a large number of mobile personnel that usually maintain a horizontal flow, i.e. with other mobile personnel, of communication and a vertical flow, i.e. with a command center, of communication. Initially, mobile personnel are typically issued a personal handheld transceiver, for example, a walkie-talkie, to provide access to both horizontal and vertical flows of communication.

The typical handheld transceiver may operate in the very high frequency (VHF) range of 30 MHz to 300 MHz or the ultra-high frequency (UHF) range of 300 MHz and 3,000 MHz, and may provide only voice communications. Nonetheless, the typical handheld transceiver has a long range and does not require a network infrastructure, for example, base stations and repeaters, to operate.

Workers in the service industries used to wear sizable or sometime heavy analog two-way radios, which limited their mobility and communication quality. Analog radio frequency wasn't stable enough when transmitted in an environment covered by lots of firm structures and furnitures.

What is needed is a device is pocket sized, compact, and easy-to-use without programming frequencies. It also works as digital frequency, which ensures the strong communication quality regardless of the working environment

### SUMMARY

In an embodiment, the system includes a portable radio communications device is for transmitting data and voice communications. The portable radio communications device may include a portable housing, a radio transceiver operating at a frequency in a range of 30 MHz-3000 MHz and being carried by the portable housing for direct communication with a corresponding radio transceiver. The portable radio communications device may also include a controller carried by the portable housing for selectively allocating transmission of the data and voice communications for the radio transceiver.

In another embodiment, the device includes a portable radio communications device is for transmitting data and voice communications. The portable radio communications device may include a portable housing, a radio transceiver operating at a frequency in a range of 30 MHz-3000 MHz and being carried by the portable housing for direct communication with a corresponding radio transceiver. The portable radio communications device may also include a controller carried by the portable housing for selectively allocating transmission of the data and voice communications for the radio transceiver.

In still another embodiment, a portable radio communications device is for transmitting data and voice communications. The portable radio communications device may include a portable housing, a radio transceiver operating at a frequency in a range of 30 MHz-3000 MHz and being carried by the portable housing for direct communication with a corresponding radio transceiver. The portable radio communications device may also include a controller carried by the portable housing for selectively allocating transmission of the data and voice communications for the radio transceiver.

### BRIEF DESCRIPTION OF THE DRAWINGS

The present invention is described in detail below with reference to the attached drawing figures, which are incorporated by reference herein and wherein:

FIG. 1 is a front view of the portable radio communication device.

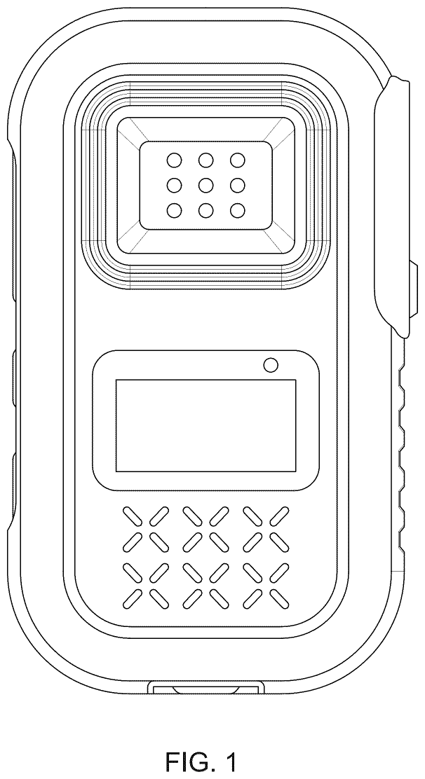

FIG. 2 is a side view of the portable radio communication device.

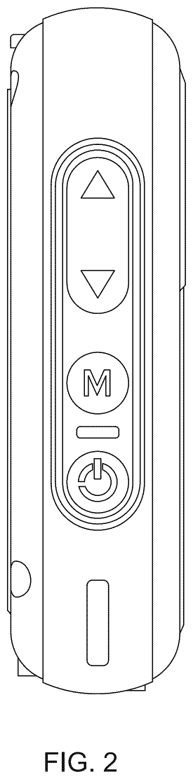

FIG. 3 is the other side view of the portable radio communication device;

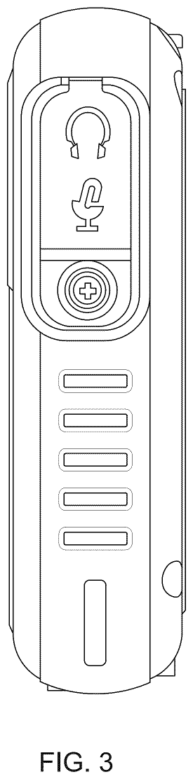

FIG. 4 is the bottom view of the portable radio communication device;

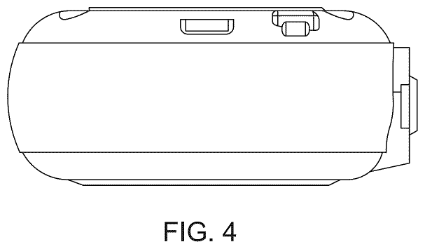

FIG. 5 is the top view of the portable radio communication device.

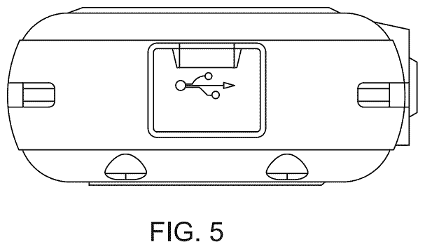

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent application, which would still fall within the scope of the claims.

It should also be understood that, unless a term is expressly defined in this patent using the sentence, there is no intent to limit the meaning of that term, either expressly or by implication, beyond its plain or ordinary meaning, and such term should not be interpreted to be limited in scope based on any statement made in any section of this patent application (other than the language of the claims). To the extent that any term recited in the claims at the end of this patent application is referred to in this patent application in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

In an embodiment, the present invention includes a Maxon MBR-400 is a simple, compact digital business radio perfect for restaurants, supermarkets, social clubs, and stores. The device is pocket-sized, it fits perfectly in your hand and can be used with an earpiece (included) or its 1W loudspeaker. With a built-in antenna and unobtrusive swivel belt clip, a user may be able to act freely and barely notice you are wearing a radio as you communicate to the rest of your coworkers throughout your day. Digital audio ensures conversations are loud & clear.

In still another embodiment, the present invention includes one or more features: Preprogrammed w/ 16 common Jobsite frequencies in DMR Digital; Programmable (UHF 440-470 MHz) for Digital (DMR Tier II TDMA), Analog, or Mixed Mode per Channel via CPS; 16 Channels, 1 Zone; Watt (High)/0.5 W (Low) Built in Speaker & MIC (1 Watt Audio output); IP54 certified protected against blowing rain; Built-in Battery (DC+3.7V Li-ion/2,000 Mah); 18 hr talk time; Encryption Mode (AES256); Scan Mode; Channel and Battery Remaining announcement; Spanish Language (menus); Voice recording and playback; Lone Worker (Safety Feature); Emergency/Siren (Programmable Key); Remote Radio Stun/Revive (Disable Target Radio)/Time; Out Timer (TOT); Vibration Function; VOX (Hands Free TX/RX), “C” Style Earpiece Included; (VOX Enabled); Over the Air Program Cloning; etc.

In yet another embodiment, the present invention includes:
Frequency Range
440~470 MHz
   Frequency Stability
±1.5 ppm (−30° to 60° C.)
   Programmable Channels
16 Channels, 1 Zone
   Channel Spacing
12.5 KHz
   Digital Vocoder
AMBE++ Voice Compression Algorithm
   Dimensions
86 mm(H)×51.5 mm(W)×22 mm(D)
   Weight
100 g
   Power Source
DC+3.7V Li-ion 2,000 mAH Battery (Built-in)
   Current Drain (maximum)
Receive mode, rated audio out—420 (Audio Max)
Transmit mode—1,200 mA
Standby mode—100 mA

In another embodiment, the present invention includes a transmitter configuration:
RF Power Output
2 Watt (High)/0.5 W (Low)
   Adjacent Channel Power
60 dB
   Spurious and Harmonic
−36 dBm(<1 GHz), −30 dBm(>1 GHz)
   FM Hum and Noise
40 dB (12.5 KHz)
   Audio Distortion
3% maximum with 1 KHz modulation
   Audio Frequency Response
+1, −3 dB from 6 dB per octave pre-emphasis Characteristic from 300~3000 Hz
   Output Impedance
50 ohms

In another embodiment, the present invention includes a receiver configuration:
Sensitivity
0.25 uV 12 dB SINAD
   Squelch Sensitivity
0.22 uV 10 dB SINAD
   Selectivity
60 dB (12.5 KHz)
   Spurious and Harmonic Rejection
−36 dBm(<1 GHz),
−30 dBm(>1 GHz)
   FM Hum and Noise
40 dB (12.5 KHz)
   Audio Output Power
1 Watt across an 8 ohm load
   Audio Distortion
Less than 3% at rated output
   Audio Response
+1, −3 dB from 6 dB per octave de-emphasis Characteristic from 300~3000 Hz
   Input Impedance
50 ohms

In another embodiment, the present invention includes a First Responder Communications System (FRCS), also referred to as an Automated Incident Control System, is provided that supports inter-agency and intra-agency communications among first responders including fire, police, border patrol, emergency medical service, safety, and/or other agencies. The FRCS also increases situational awareness of personnel by automatically providing position information as well as other sensor information. The FRCS also provides position and time information via Global Positioning System (GPS) and/or other positioning systems, and data from deployed and/or personal sensors to provide enhanced communications, command and control capabilities to the first responders and incident command. The FRCS includes a heads up display (HUD) including one or more LEDs or LCDs and a signal receiver that attaches to a faceshield or windshield (shield) to receive/display instructions via an electromagnetic or sonic signal via a transmitter coupled to a computer or other source.

In still another embodiment, the present invention includes a portable radio communications device is for transmitting data and voice communications. The portable radio communications device may include a portable housing, a radio transceiver operating at a frequency in a range of 30 MHz-3000 MHz and being carried by the portable housing for direct communication with a corresponding radio transceiver, and a metropolitan area network (MAN) transceiver carried by the portable housing for indirect communication with a corresponding MAN transceiver via a MAN base station. The portable radio communications device may also include a controller carried by the portable housing for selectively allocating transmission of the data and voice communications between the radio transceiver and the MAN transceiver based upon a received signal characteristic. The controller may preferentially allocate the voice communications and the data communications to the radio transceiver and the MAN transceiver, respectively.

In yet another embodiment, the present invention includes a modular, portable data collection terminals are disclosed for use in mixed wireless and hard-wired RF communication networks, wherein various radio transmitter modules and associated antennas may be selectively added to a base terminal unit to solve networking problems associated with specific types of business environments. Modularity exists in both the hardware (splitting data collection and processing control circuitry from radio transceiver control circuitry) and software (splitting transceiver-specific, lower level communication protocol from generic, higher level communication protocol). The control circuitry, including associated microprocessors devices, interact to selectively activate communication circuits to perform necessary communication or data processing functions and enter and remain in a power-saving dormant state during other times. To support such dormant or “sleeping” states, a series of communication protocols provide for channel access to the communication network.

In another embodiment, the present invention includes systems and methods for wireless communication are provided. In a particular embodiment, a base station device is disclosed that includes an interface coupled to a network to communicate with a central controller and a wireless transceiver adapted to communicate wirelessly with one or more portable devices via a local area network. The base station device also includes logic coupled to the interface and to the wireless transceiver. The logic communicates with the remote central controller device via the network to receive an authorization to communicate wirelessly. The logic selectively activates the wireless transceiver after receiving the authorization.

Many different arrangements of the various components depicted, as well as components not shown, are possible without departing from the spirit and scope of the present invention. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described

1. A system having a portable radio communications device for transmitting data and voice communications comprising:
a portable housing;
a radio transceiver operating at a frequency in a range of 30 MHz-3000 MHz and being carried by the portable housing for direct communication with a corresponding radio transceiver; and
a controller carried by the portable housing for selectively allocating transmission of the data and voice communications for the radio transceiver.

2. The system of claim 1, wherein the system has a frequency range is 440-470 MHz.

3. The system of claim 1, wherein the system has a frequency stability is 1.5 ppm.

4. The system of claim 1, wherein the system has 16 programmable channels.

5. The system of claim 1, wherein the system has a channel spacing of 12.5 KHz.

6. The system of claim 1, wherein the weight is 100 g.

7. The system of claim 1, wherein the standby mode is 110 mA.

8. A portable radio communications device for transmitting data and voice communications comprising:
a portable housing;
a radio transceiver operating at a frequency in a range of 30 MHz-3000 MHz and being carried by the portable housing for direct communication with a corresponding radio transceiver; and
a controller carried by the portable housing for selectively allocating transmission of the data and voice communications for the radio transceiver.

9. The device of claim 8, wherein the device has a frequency range is 440-470 MHz.

10. The device of claim 8, wherein the device has a frequency stability is 1.5 ppm.

11. The device of claim 8, wherein the device has 16 programmable channels.

12. The device of claim 8, wherein the device a channel spacing of 12.5 KHz.

13. The device of claim 8, wherein the weight is 100 g.

14. The device of claim 8, wherein the standby mode is 110 mA.
